(19) United States
(12) Patent Application Publication
(10) Pub. No.: US 2020/0125105 A1
(43) Pub. Date: Apr. 23, 2020

(54) Method for Creating Grid Map of Intelligent Robot

(71) Applicant: AMICRO SEMICONDUCTOR CO., LTD., Zhuhai, Guangdong (CN)

(72) Inventors: Gangjun XIAO, Zhuhai,Guangdong (CN); Ming LI, Zhuhai,Guangdong (CN)

(21) Appl. No.: 16/604,568

(22) PCT Filed: Apr. 11, 2017
(86) PCT No.: PCT/CN2017/080136

§ 371 Date: Oct. 11, 2019

(51) Int. Cl. G05D 1/02

(52) U.S. Cl. CPC G05D 1/0219; G05D 1/0214; G05D 1/0225; G05D 2201/0215; G05D 1/0238; G05D 2201/0203; G05D 1/0274

(57) ABSTRACT

A method for creating a grid map of an intelligent robot includes: step (1) controlling a motion of the intelligent robot; step (2) detecting whether an action of the intelligent robot at a current position is an edgewise behavior and detecting whether there is at least one obstacle at the current position; (3) executing different processings according to a result detected by step (2).

### TECHNICAL FIELD

The present disclosure relates to the technical field of intelligent control, and in particular to a method for creating a grid map of an intelligent robot.

### BACKGROUND

As a key factor in the transformation of world economy and industrial growth mode, intelligent robots are entering a new stage of development. Intelligent robots are manufacturing equipment, equipment tools, and consumer goods with perception, decision, and execution. The manufacturing equipment intelligent robots used in production processes and environments are called industrial robots. The consumer goods intelligent robots for personal or domestic services are called home service robots. The equipment tool intelligent robots for operation and maintenance in special environments are called special service robots.

A household sweeping robot is taken as an example. The household sweeping robot is also called an automatic sweeping machine, an intelligent vacuum cleaner, a robot vacuum cleaner, etc., and is a kind of intelligent household appliance, which can automatically clean a floor in a room with certain artificial intelligence.

The sweeping robot covers the entire room area according to a certain path plan to complete the purpose of traversal. Path planning includes random traversal and planning traversal.

The random traversal means that the sweeping robot tentatively covers an operation area according to a certain movement algorithm, such as a triangular trajectory or a pentagonal trajectory. When the sweeping robot encounters at least one obstacle, a corresponding steering function is executed. This method is a low-cost strategy with time to exchange for space, such as 100% coverage excluding time spent. Random coverage does not require positioning, an environmental map and path planning. This method is used by most of sweeping robots namely iRobot currently.

The planning traversal means that an environment map is created during the sweeping robot walking process, the environment map is analyzed in real time and a new path plan is completed, and all the rooms are cleaned. This method is highly efficient and can complete cleaning as quickly as possible while maintaining coverage.

Cleaning planning is to solve three problems as follows.

At problem one, the environment map is created, and a position of the sweeping robot is determined.

At problem two, the sweeping robot is navigated from an initial position to a target position, and the sweeping robot may automatically avoid any obstacle in a navigation process.

At problem three, a method for traversal of the entire room is provided.

There are various solutions for problem one, such as a grid method, an artificial potential field method, a template model method, or an artificial intelligence method.

The artificial potential field method is to design a motion of a robot in a surrounding environment into a motion in a potential field. There are two kinds of potential energy: a repulsion pole and a gravitation pole. Areas and obstacles that are not expected to enter are repulsion poles, and areas recommended to pass are gravitation poles. A combined force of gravitation and repulsion is used as an acceleration force of the sweeping robot to control a direction of motion of the intelligent robot and calculate the position of the sweeping robot. However, this method usually has problems of local minimum points and excessive calculations.

The template model method is to match environmental information, obtained by a traversal robot according to prior knowledge and previous environmental maps with a predefined template. This method requires memories of a pre-defined environment model and a pre-defined template, so it is not easy to deal with changing environment, such as an obstacle suddenly appeared in a process of the traversal robot.

The artificial intelligence method includes a fuzzy control algorithm, neural network path planning, a genetic algorithm, etc. These algorithms are computationally intensive and mostly in the laboratory research phase, with less practical use.

The grid method uses a grid of the same size to divide a workspace of the sweeping robot and uses a grid array to represent the environment. A state of each grid includes one of the followings: the sweeping robot being in a free space and the sweeping robot being in at least one obstacle space. This method is simple and easy to implement, which brings a lot of convenience to realization of path planning, and has the ability to represent irregular obstacles. However, the disadvantage of this method is that representation efficiency is not high, and there is a contradiction between space-time overhead and precision. When the grid is divided to be large, a storage of environmental information is small, planning time is short, environment resolution is reduced, and ability to find paths in a dense environment is weakened. When the grid is divided to be small, the environment resolution is high, the ability to find paths in a dense environment is strong, but the storage of environmental information is large. So the size of the grid directly affects the performance of a control algorithm.

### SUMMARY

At least some embodiments of present disclosure provide a method for utilizing the maximum efficiency of a grid map, which can meet precision requirements of an intelligent robot and meet sweeping range requirements of the intelligent robot. The object of the present disclosure is achieved by the following technical solutions.

In a method for creating a grid map of an intelligent robot, the intelligent robot including an action body, a main control component, a sensor set, a power component, and a regional operation component, the method for creating the grid map including:

step (1) controlling a motion of the intelligent robot;

step (2) detecting whether an action of the intelligent robot at a current position is an edgewise behavior and detecting whether there is at least one obstacle at the current position, when the action at the current position is the edgewise behavior but there is no obstacle at the current position, proceeding to step (3a), when the action at the current position is the edgewise behavior and there is at least one obstacle at the current position, proceeding to step (3b), when the action at the current position is not the edgewise behavior but there is at least one obstacle, proceeding to step (3c), and when the action at the current position is not the edgewise behavior and there is no obstacle, proceeding to step (3d);

step (3a) marking a grid at the current position on the grid map as an edgewise behavior point and returning to step (1);

step (3b) marking the grid at the current position on the grid map as the edgewise behavior point, calculating coordinates of a grid where the at least one obstacle is located and marking the grid corresponding to the at least one obstacle on the grid map as at least one obstacle point, and returning to step (1);

step (3c) marking the grid at the current position on the grid map as a normal passing point, calculating coordinates of a grid where the at least one obstacle is located and marking the corresponding grid as at least one obstacle point, and returning to step (1); and

step (3d) marking the grid at the current position on the grid map as a normal passing point and returning to step (1).

In an optional embodiment, in a process of creating the grid map, a grid of a starting point of the motion of the intelligent robot on the grid map is marked as the normal passing point.

In an optional embodiment, each grid in the grid map is represented by a digital sequence, the digital sequence including: a digital segment indicating an area where each grid is located, a digital segment indicating whether the intelligent robot has reached each grid, a digital segment indicating whether each grid has at least one obstacle, and a digital segment indicating that the intelligent robot passes through each grid when the intelligent robot performing the edgewise behavior.

In an optional embodiment, a method for calculating the coordinates of the grid where the at least one obstacle is located includes:

step A, calculating a distance from each obstacle point of the at least one obstacle to a center point of the intelligent robot;

step B, calculating an actual angle between each obstacle point of the at least one obstacle and the center point of the intelligent robot;

step C, calling a trigonometric function to calculate coordinates of each obstacle point with respect to the center point of the intelligent robot; and

step D, adding calculated coordinates to coordinates of the center point of the intelligent robot to obtain the coordinates of the grid where the at least one obstacle is located.

In an optional embodiment, at step (1), when each time the motion of the intelligent robot is controlled, a grid map translation sub-process is first executed, this sub-process including:

step a, detecting whether it is necessary to translate the entire grid map, and when a grid actually used in one direction of an x axis or a y axis of the grid map has reached a boundary of the entire grid map and the remaining grids are not used in an opposite direction an x axis or a y axis of the grid map, proceeding to step b, and otherwise, quitting the sub-process;

step b, determining the number of grids to be actually translated at this time according to a difference between the number of previous offset grids of the x axis and the y axis and the number of current offset grids of the x axis and the y axis; and

step c, translating the entire grid map according to the number of grids to be actually translated at this time.

In an optional embodiment, when a translation function is activated, a small amount of memory is opened as a buffer to store grid map data that has been out of bounds, and when the entire grid map is translated, the buffered grid data is written to the grid map.

The method for creating the grid map of the intelligent robot provided by at least some embodiments of the present disclosure can utilize the maximum efficiency of a grid map, which can meet the precision requirements of an intelligent robot and meet the sweeping range requirements of the intelligent robot.

### BRIEF DESCRIPTION OF THE DRAWINGS

FIG. 1 is a block composition diagram of an intelligent robot in a method for creating a grid map according to an embodiment of the present disclosure.

FIG. 2 is a main flowchart of a method for creating a grid map according to an embodiment of the present disclosure.

FIG. 3 is a flowchart of a method for calculating obstacle grid coordinates in a method for creating a grid map according to an embodiment of the present disclosure.

FIG. 4 is a flowchart of initiating map translation in a method for creating a grid map according to an embodiment of the present disclosure.

FIG. 5 is a flowchart of determining a map translation grid number in a method for creating a grid map according to an embodiment of the present disclosure.

FIG. 6 is a flowchart of realizing a map translation operation in a method for creating a grid map according to an embodiment of the present disclosure.

FIG. 7 is a flowchart of realizing data reading of a buffer operation in a map translation process in a method for creating a grid map according to an embodiment of the present disclosure.

FIG. 8 is a flowchart of realizing data writing of a buffer operation in a map translation process in a method for creating a grid map according to an embodiment of the present disclosure.

### DETAILED DESCRIPTION

The specific implementation manners present disclosure will be further described below with reference to the accompanying drawings.

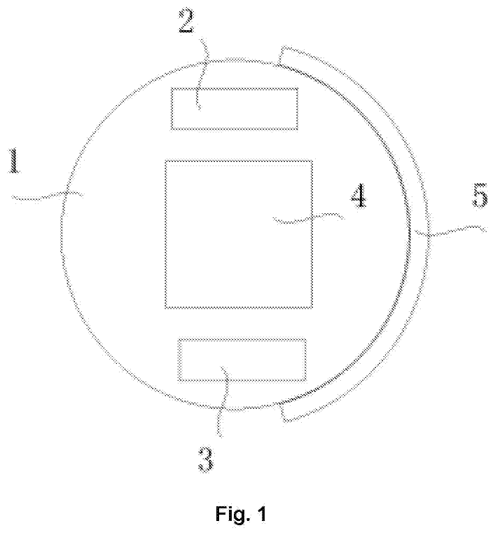

As shown in FIG. 1, in a method for creating a grid map of an intelligent robot provided by the present embodiment, the intelligent robot includes an action body 1, a main control component 4, a sensor set 5, a power component, and a regional operation component. The action body 1 includes a housing and action wheels 2, 3. The sensor set 5 includes a collision detection sensor, an obstacle detection sensor, a distance information sensor, and an angle information sensor, all of which are electrically connected with the main control component.

Specifically, the collision detection sensor is configured to determine, when the intelligent robot encounters at least one obstacle, that the current collision with the at least one obstacle occurs, and notify the main control component 4. A fall prevention detection sensor is configured to determine, when the intelligent robot is suspended, that it is currently in a dangerous state, and notify the main control component 4. The obstacle detection sensor is configured to detect whether the at least one obstacle is present around the intelligent robot and notify the main control component 4. The obstacle detection sensor includes the fall prevention detection sensor and a peripheral detection sensor. The peripheral detection sensor is composed of front, front left, front right, left, and right infrared ranging sensors. The distance information sensor is a wheel encoder, and the angle information sensor is a gyroscope. The regional operation component refers to a component that performs certain functional operations on an area where the intelligent robot is located, and may be at least one of a cleaning component, a camera component, a humidification component, a dehumidification component, and a pest control component. The present embodiment takes the cleaning component as an example. That is, the intelligent robot described in the present embodiment is a sweeping robot.

In the method for creating the grid map of the intelligent robot provided in the present embodiment, a grid map is used when creating the map. Distance information acquired by the distance information sensor, angle information acquired by the angle information sensor, collision information acquired by the collision detection sensor, and obstacle information acquired by the obstacle detection sensor are used for creating the grid map, and at least one normal passing point, at least one obstacle point and at least one edgewise point are recorded. The intelligent robot updates the grid map while moving, and updates the status to the grid map as long as the intelligent robot passes. Understandably, as the grid is smaller, the precision is higher, but due to a limitation of a memory and an operation speed, a square is selected as a shape of each grid and each side length of the square is one third of a diameter of the intelligent robot.

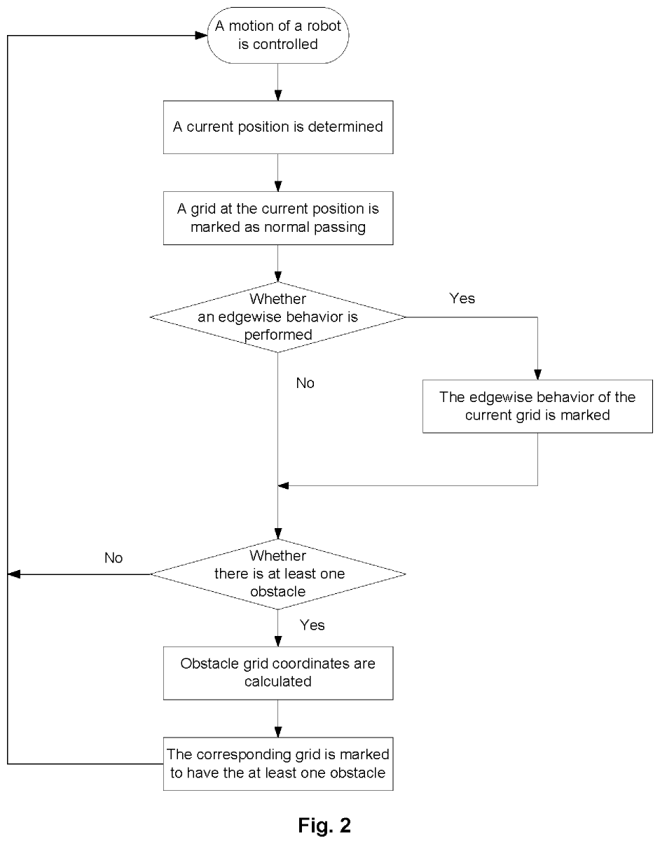

As shown in FIG. 2, the method for creating a grid map of an intelligent robot provided by the present embodiment includes the following steps.

At step (1), a motion of the intelligent robot is controlled.

At step (2), it is detected whether an action of the intelligent robot at a current position is an edgewise behavior and detecting whether there is at least one obstacle at the current position. When the action at the current position is the edgewise behavior but there is no obstacle at the current position, proceeding to step (3a). When the action at the current position is the edgewise behavior and there is at least one obstacle at the current position, proceeding to step (3b). When the action at the current position is not the edgewise behavior but there is at least one obstacle, proceeding to step (3c). And when the action at the current position is not the edgewise behavior and there is no obstacle, proceeding to step (3d).

At step (3a), a grid at the current position on the grid map is marked as an edgewise behavior point, and the process returns to step (1).

At step (3b), the grid at the current position on the grid map is marked as the edgewise behavior point, coordinates of a grid where the at least one obstacle is located are calculated and the grid corresponding to the at least one obstacle on the grid map is marked as at least one obstacle point, and the process returns to step (1).

At step (3c), the grid at the current position on the grid map is marked as a normal passing point, coordinates of a grid where the at least one obstacle is located are calculated and the grid corresponding to the at least one obstacle on the grid map is marked as at least one obstacle point, and the process returns to step (1).

At step (3d), the grid at the current position on the grid map is marked as a normal passing point and the process returns to step (1).

In the flowchart of FIG. 2, some of the above methods are represented for better performance, and the edgewise behavior determination and the at least one obstacle determination are successively represented. In fact, the two determinations are partially sequential.

The created grid map is saved in the main control component 4 and managed by the main control component 4. The representation of the grid map may be as follows. A black grid indicates that the intelligent robot does not mark the grid. A green grid represents the normal passing point determined by the intelligent robot. A red grid represents the at least one obstacle point sensed by the obstacle detection sensor. A blue grid represents the at least one obstacle point at a collision position detected by the collision detection sensor. And a white grid represents the edgewise behavior point.

Each grid is represented by an 8-bit number. The higher four bits of the 8-bit number record area information and indicate an area where each grid is located. The lower four bits of the 8-bit number are used for representing actual information of the grid map. A 0th bit indicates whether the intelligent robot has reached each grid. A value 0 of the 0th bit indicates that the intelligent robot has not reached this grid, and a value 1 of the 0th bit indicates that the intelligent robot has not reached this grid. A 1st bit indicates whether each grid has at least one obstacle. A value 0 of the 1st bit indicates that this grid has no obstacle, and a value 1 of the 1st bit indicates that this grid has at least one obstacle. A 2nd bit indicates whether the intelligent robot passes through each grid when the intelligent robot performing the edgewise behavior.

A value 1 of the 2nd bit indicates that the intelligent robot passes through this grid, and a value 0 of the 2nd bit indicates that the intelligent robot does not pass through this grid. And a 3rd bit is a reserved bit.

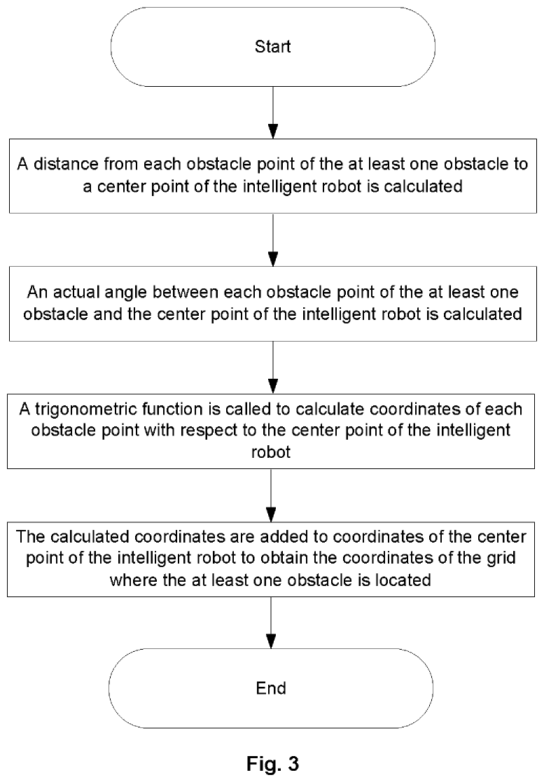

As shown in FIG. 3, in the method for creating a grid map of an intelligent robot provided by the present embodiment, the method of calculating the coordinates of a grid where the at least one obstacle is located includes the following steps.

At step A, a distance from each obstacle point of the at least one obstacle to a center point of the intelligent robot is calculated.

At step B, an actual angle between each obstacle point of the at least one obstacle and the center point of the intelligent robot is calculated.

At step C, a trigonometric function is called to calculate coordinates of each obstacle point with respect to the center point of the intelligent robot.

At step D, the calculated coordinates are added to coordinates of the center point of the intelligent robot to obtain the coordinates of the grid where the at least one obstacle is located.

The at least one obstacle point detected by the collision detection sensor and the at least one obstacle point sensed by the obstacle detection sensor are treated differently in the grid map (differentially labeled). As described above, the red grid represents the at least one obstacle point sensed by the obstacle detection sensor, and the blue grid represents the at least one obstacle point of a collision detected by the collision detection sensor, which may, of course, be uniformly labeled (for example, all labeled in red). However, regardless of which sensor senses at least one obstacle, the distance and angle may be calculated as follows.

A distance from each obstacle point of the at least one obstacle to the center point of the intelligent robot is equal to a sum of a distance detected by a sensor and a radius of the intelligent robot.

An angle between each obstacle point of the at least one obstacle and the center point of the intelligent robot is equal to a sum of a front angle of the intelligent robot and a difference of angle at which a position of the sensor deviates from the front of the intelligent robot.

In the method for creating the grid map of the intelligent robot provided in the present embodiment, the starting point of the intelligent robot is generally located at the center point of the grid map. The grid map is fixed in size, and if a prototype always sweeps in one direction, the grid map is easily out of bounds. The grid map is out of bounds in one direction, and the grid map in the opposite direction of this direction is empty and unused.

The following describes a method for translating the entire grid map in real time according to the situation that the actually used map is out of bounds, so that the actually used map is always located at the center point of the entire grid map until the length or width of the actually used map truly reaches the limit of the entire grid map.

At step (1) of the method for creating the grid map of the intelligent robot as described above, when each time the motion of the intelligent robot is controlled, a grid map translation sub-process is first executed. This sub-process includes the following steps.

At step a, it is detected whether it is necessary to translate the entire grid map. And when a grid actually used in one direction of an x axis or a y axis of the grid map has reached a boundary of the entire grid map and the remaining grids are not used in an opposite direction of an x axis or a y axis of the grid map, the process proceeds to step b to start the translation of the entire grid map, and otherwise, the sub-process is quit.

At step b, the number of grids to be actually translated at this time is determined according to a difference between the number of previous offset grids of the x axis and the y axis and the number of current offset grids of the x axis and the y axis.

At step c, the entire grid map is translated according to the number of grids to be actually translated at this time.

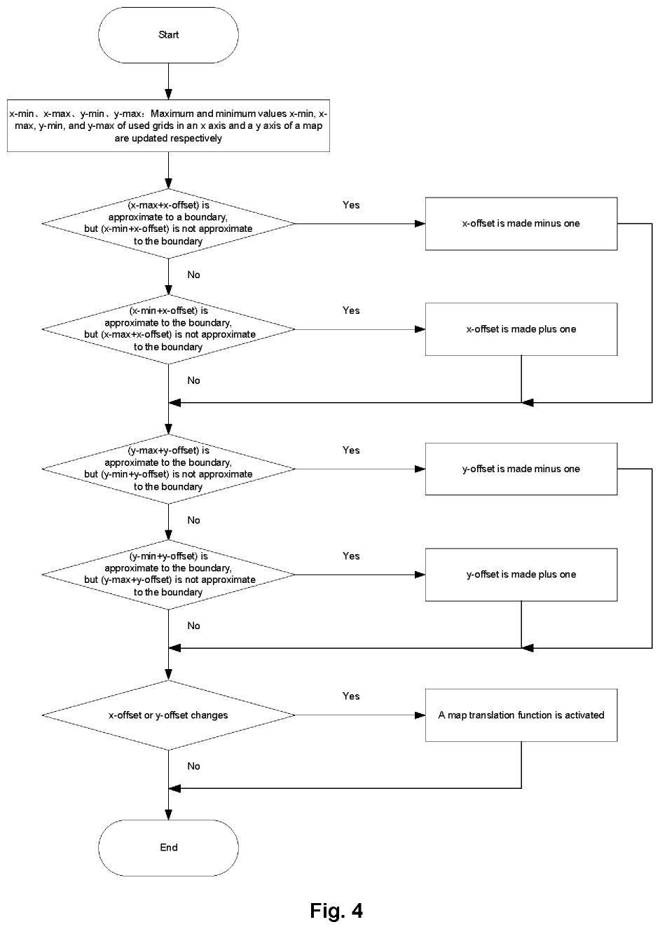

As shown in FIG. 4, x-min and x-max are minimum and maximum values of the used grid in the x-axis direction, y-min and y-max are minimum and maximum values of the used grid in the y-axis direction, and x-offset and y-offset record actual grid offsets in the x-axis and y-axis directions of the current grid map.

The method of step a in the map translation sub-process specifically includes the following steps.

At step a1, maximum and minimum values x-min, x-max, y-min, and y-max of the used grids in the x axis and the y axis of the grid map are updated respectively.

At step a2, it is determined whether (x-max+x-offset) is approximate to the boundary, but (x-min+x-offset) is not approximate to the boundary, when (x-max+x-offset) is approximate to the boundary but (x-min+x-offset) is not approximate to the boundary, x-offset is made minus one and the process proceeds to step a4, otherwise, the process proceeds to step a3.

At step a3, it is determined whether (x-min+x-offset) is approximate to the boundary, but (x-max+x-offset) is not approximate to the boundary, when (x-min+x-offset) is approximate to the boundary but (x-max+x-offset) is not approximate to the boundary, x-offset is made plus one and the process proceeds to step a4, otherwise, the process proceeds directly to step a4.

At step a4, it is determined whether (y-max+y-offset) is approximate to the boundary, but (y-min+y-offset) is not approximate to the boundary, when (y-max+y-offset) is approximate to the boundary but (y-min+y-offset) is not approximate to the boundary, y-offset is made minus one and the process proceeds to step a6, otherwise, the process proceeds to step a5.

At step a5, it is determined whether (y-min+y-offset) is approximate to the boundary, but (y-max+y-offset) is not approximate to the boundary, when (y-min+y-offset) is approximate to the boundary but (y-max+y-offset) is not approximate to the boundary, y-offset is made plus one and the process proceeds to step a6, otherwise, the process proceeds directly to step a6.

At step a6, it is determined whether x-offset or y-offset changes, when x-offset or y-offset changes, the translation of the entire grid map is started, otherwise, the sub-process is quit.

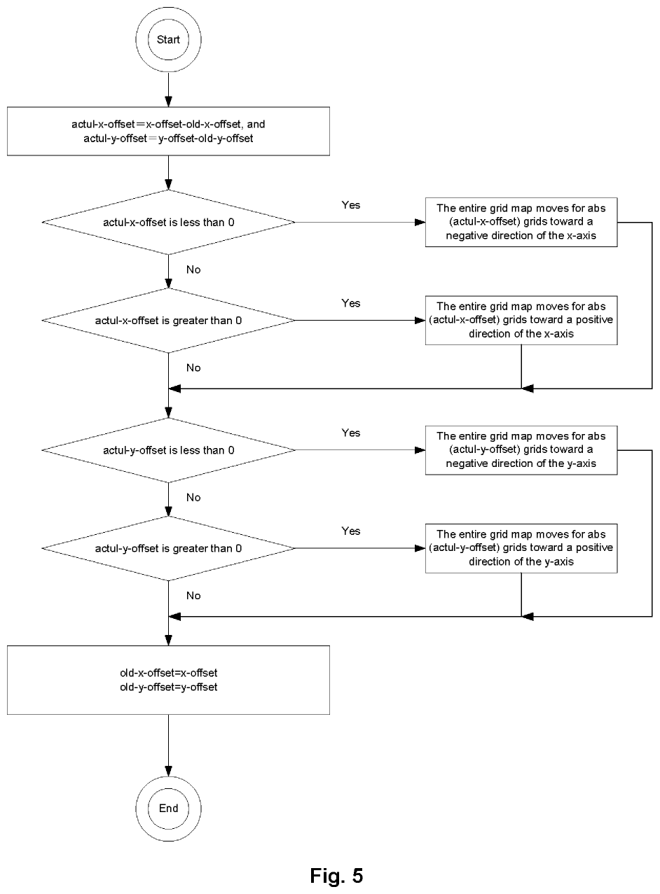

As shown in FIG. 5, x-offset and y-offset record the actual grid offsets in the x-axis and y-axis directions of the current grid map, old-x-offset and old-y-offset record the grid offsets in the x-axis and y-axis directions during the previous translation of the grid map, abs indicates an absolute value of this number, and actul-x-offset and actul-y-offset are the number of grids to be actually translated at this time.

The method of step b in the map translation sub-process includes the following steps.

At step b1, actul-x-offset=x-offset-old-x-offset, and actul-y-offset=y-offset-old-y-offset are set.

At step b2, it is determined whether actul-x-offset is less than 0, when actul-x-offset is less than 0, it is determined that the entire grid map moves for abs (actul-x-offset) grids toward a negative direction of the x-axis and the process proceeds to step b4, otherwise, the process proceeds to step b3.

At step b3, it is determined whether actul-x-offset is greater than 0, when actul-x-offset is greater than 0, it is determined that the entire grid map moves for abs (actul-x-offset) grids toward a positive direction of the x-axis and the process proceeds to step b4, otherwise, the process proceeds directly to step b4.

At step b4, it is determined whether actul-y-offset is less than 0, when actul-y-offset is less than 0, it is determined that the entire grid map moves for abs (actul-y-offset) grids toward a negative direction of the y-axis and the process proceeds to step b6, otherwise, the process proceeds to step b5.

At step b5, it is determined whether actul-y-offset is greater than 0, when actul-y-offset is greater than 0, it is determined that the entire grid map moves for abs (actul-y-offset) grids toward a positive direction of the y-axis and the process proceeds to step b6, otherwise, the process proceeds directly to step b6.

At step b6, the grid offsets old-x-offset and old-y-offset in the x-axis and y-axis directions during the previous translation of the grid map are updated with the actual grid offsets x-offset and y-offset in the x-axis and y-axis directions of the current grid map.

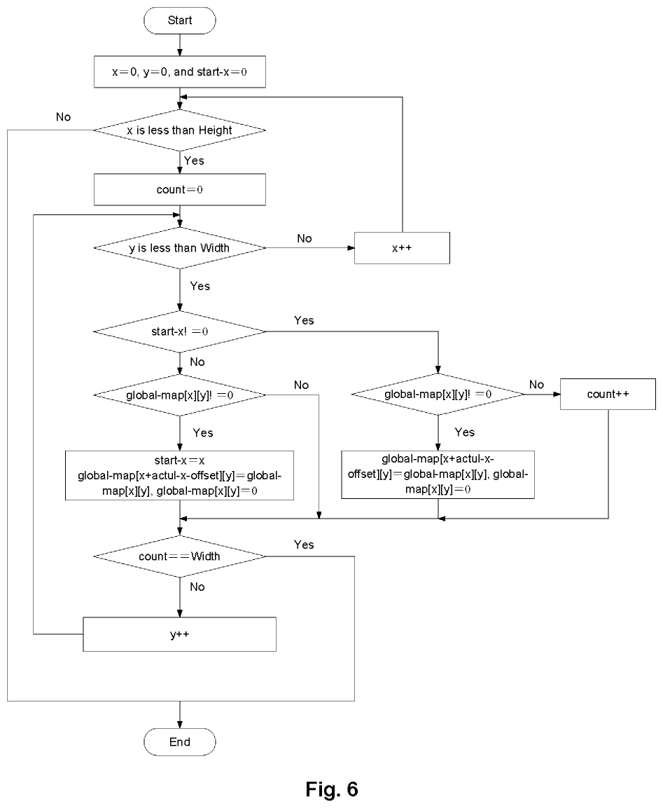

As shown in FIG. 6, global-map is a grid map array, Height and Width represent the height and width of the global-map grid array, start-x represents a row number of a first row with data not zero, that is, data from the beginning of the row needs to be translated, and count records how many grids in a row of data are zero (unused grids). If the entire row of grid data is zero, the translation operation ends.

The present embodiment is described by taking the translation of the x-axis to a negative direction as an example, that is, when the actul-x-offset is less than zero. When the entire grid map is translated, the unused grid (with zero data) does not need to be operated.

The method of step c in the map translation sub-process includes the following steps.

At step c1, x=0, y=0, and start-x=0 are set during starting.

At step c2, it is determined whether x is less than Height, when x is less than Height, the process proceeds to step c3, otherwise, the process ends.

At step c3, count=0 is set, and the process proceeds to step c4.

At step c4, it is determined whether y is less than Width, when y is less than Width, the process proceeds to step c5, otherwise, x++ is set and the process returns to step c2.

At step c5, it is determined whether start-x!=0, when start-x!=0, the process proceeds to step c51, otherwise, the process proceeds to step c6.

At step c51, it is determined whether global-map[x][y]!=0, when global-map[x][y]!=0, global-map[x+actul-x-offset][y]=global-map[x][y], global-map[x][y]=0 are set and the process proceeds to step c8, otherwise, count++ is set and the process proceeds to step c8.

At step c6, it is determined whether global-map[x][y]!=0, when global-map[x][y]!=0, the process proceeds to step c7, otherwise, the process proceeds to step c8.

At step c7, start-x=x, global-map[x+actul-x-offset][y]=global-map[x][y], global-map[x][y]=0 are set, and the process proceeds to step c8.

At step c8. it is determined whether count==Width, when count==Width, the process ends, otherwise, y++ is set and the process returns to step c4.

When actul-x-offset is greater than zero, in the above flow chart, it is to set an initial value of x to Height−1, after each cycle, x−− is executed, and the process ends until x<0.

The translation principle of the y-axis is the same as that of the x-axis.

In addition, when the translation function is activated, it is not suitable to translate the entire grid map immediately. It is best to wait for the prototype to stop when it is translated. Because the entire grid map is translated, it is very CPU-intensive and affects the smoothness of the sweeper movement.

In order to prevent the grid map from crossing the boundary during this waiting process, a small amount of memory must be opened as a buffer to store grid map data that has been out of bounds. When the entire grid map is translated, the buffered grid data is written to the grid map. Therefore, when reading or writing the grid map data, it is necessary to consider whether there is a buffer.

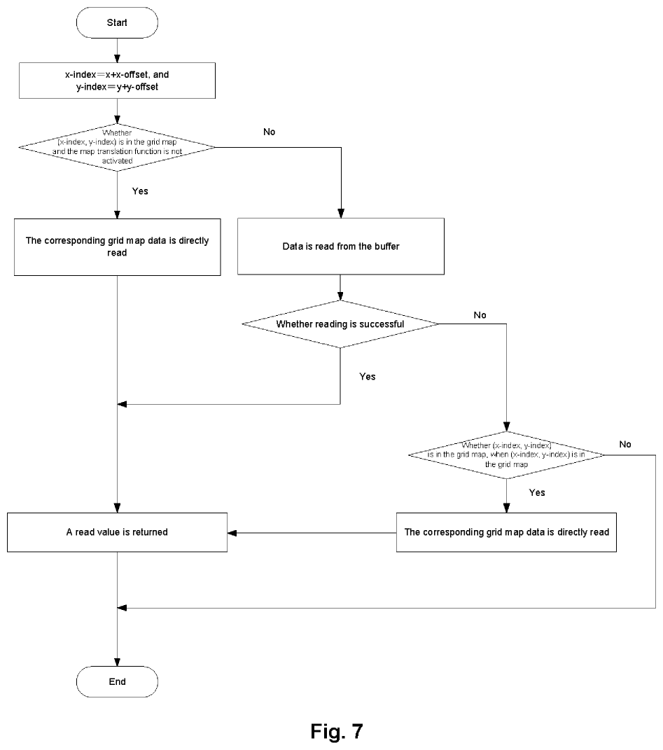

As shown in FIG. 7, the process of reading data in a corresponding buffer method provided by the present embodiment is as follows.

At step S1, x-index=x+x-offset, and y-index=y+y-offset are set.

At step S2, it is determined whether (x-index, y-index) is in the grid map and the map translation function is not activated, when (x-index, y-index) is in the grid map and the grid map translation function is not activated, the process proceeds to step S3, otherwise, the process proceeds to step S2a.

At step S2a, data is read from the buffer, and the process proceeds to step S2b.

At step S2b, it is determined whether reading is successful, when the reading is successful, the process proceeds to step S4, otherwise, the process proceeds to step S2c.

At step S2c, it is determined whether (x-index, y-index) is in the grid map, when (x-index, y-index) Is in the grid map, the process proceeds to step S2d, otherwise, the process returns to zero and ends.

At step S2d, the corresponding grid map data is directly read and the process proceeds to step S4.

At step S3, the corresponding grid map data is directly read and the process proceeds to step S4.

At step S4, a read value is returned, and the process ends.

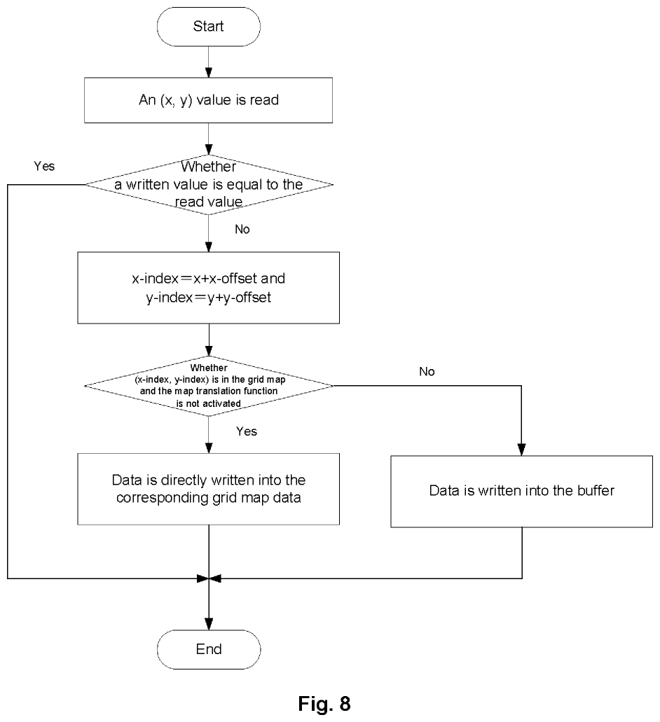

As shown in FIG. 8, the process of writing data in a corresponding buffer method provided by the present embodiment is as follows.

At step T1, an (x, y) value is read and the process proceeds to step T2.

At step T2, it is determined whether a written value is equal to the read value, when the written value is equal to the read value, the process ends, otherwise, x-index=x+x-offset and y-index=y+y-offset are set, and the process proceeds to step T3.

At step T3, it is determined whether (x-Index, y-index) is in the grid map and the map translation function is not activated, when (x-index, y-index) is in the grid map and the grid map translation function is not activated, data is directly written into the corresponding grid map data and the process ends, otherwise, data is written into the buffer and the process ends.

x and y are the grid coordinates at which the intelligent robot is currently located, and x-index and y-index are the actual coordinates of the corresponding grid map.

The above embodiments are for the purpose of fully disclosing and not limiting the present disclosure, and the substitution of equivalent technical features based on the inventive subject matter and without creative labor should be regarded as the scope of the present disclosure.

What is claimed is:

1. A method for creating a grid map of an intelligent robot, the intelligent robot comprising an action body, a main control component, a sensor set, a power component, and a regional operation component, the method for creating the grid map comprising:
step (1) controlling a motion of the intelligent robot;
step (2) detecting whether an action of the intelligent robot at a current position is an edgewise behavior and detecting whether there is at least one obstacle at the current position, when the action at the current position is the edgewise behavior but there is no obstacle at the current position, proceeding to step (3a), when the action at the current position is the edgewise behavior and there is at least one obstacle at the current position, proceeding to step (3b), when the action at the current position is not the edgewise behavior but there is at least one obstacle, proceeding to step (3c), and when the action at the current position is not the edgewise behavior and there is no obstacle, proceeding to step (3d);
step (3a) marking a grid at the current position on the grid map as an edgewise behavior point and returning to step (1);
step (3b) marking the grid at the current position on the grid map as the edgewise behavior point, calculating coordinates of a grid where the at least one obstacle is located and marking the grid corresponding to the at least one obstacle on the grid map as at least one obstacle point, and returning to step (1);
step (3c) marking the grid at the current position on the grid map as a normal passing point, calculating coordinates of a grid where the at least one obstacle is located and marking the corresponding grid as at least one obstacle point, and returning to step (1); and
step (3d) marking the grid at the current position on the grid map as a normal passing point and returning to step (1).

2. The method for creating the grid map of the intelligent robot as claimed in claim 1, wherein in a process of creating the grid map, a grid of a starting point of the motion of the intelligent robot on the grid map is marked as the normal passing point.

3. The method for creating the grid map of the intelligent robot as claimed in claim 1, wherein each grid in the grid map is represented by a digital sequence, the digital sequence comprising: a digital segment indicating an area where each grid is located, a digital segment indicating whether the intelligent robot has reached each grid, a digital segment indicating whether each grid has at least one obstacle, and a digital segment indicating that the intelligent robot passes through each grid when the intelligent robot performing the edgewise behavior.

4. The method for creating the grid map of the intelligent robot as claimed in claim 3, wherein each grid is represented by an 8-bit number, the higher four bits of the 8-bit number record area information and indicate an area where each grid is located, the lower four bits of the 8-bit number are used for representing actual information of the grid map, wherein a 0th bit indicates whether the intelligent robot has reached each grid, a value 0 of the 0th bit indicates that the intelligent robot has not reached this grid, and a value 1 of the 0th bit indicates that the intelligent robot has not reached this grid; a 1st bit indicates whether each grid has at least one obstacle, a value 0 of the 1st bit indicates that this grid has no obstacle, and a value 1 of the 1st bit indicates that this grid has at least one obstacle; a 2nd bit indicates whether the intelligent robot passes through each grid when the intelligent robot performing the edgewise behavior, a value 1 of the 2nd bit indicates that the intelligent robot passes through this grid, and a value 0 of the 2nd bit indicates that the intelligent robot does not pass through this grid; and a 3rd bit is a reserved bit.

5. The method for creating the grid map of the intelligent robot as claimed in claim 1, wherein a method for calculating the coordinates of the grid where the at least one obstacle is located comprises:
step A, calculating a distance from each obstacle point of the at least one obstacle to a center point of the intelligent robot;
step B, calculating an actual angle between each obstacle point of the at least one obstacle and the center point of the intelligent robot;
step C, calling a trigonometric function to calculate coordinates of each obstacle point with respect to the center point of the intelligent robot; and
step D, adding calculated coordinates to coordinates of the center point of the intelligent robot to obtain the coordinates of the grid where the at least one obstacle is located.

6. The method for creating the grid map of the intelligent robot as claimed in claim 5, wherein the distance from each obstacle point of the at least one obstacle to the center point of the intelligent robot and the actual angle between each obstacle point of the at least one obstacle and the center point of the intelligent robot are calculated according to the following formula:
a distance from each obstacle point of the at least one obstacle to the center point of the intelligent robot is equal to a sum of a distance detected by a sensor and a radius of the intelligent robot; and
an angle between each obstacle point of the at least one obstacle and the center point of the intelligent robot is equal to a sum of a front angle of the intelligent robot and a difference of angle at which a position of the sensor deviates from the front of the intelligent robot.

7. The method for creating the grid map of the intelligent robot as claimed in claim 1, wherein at step (1), when each time the motion of the intelligent robot is controlled, a grid map translation sub-process is first executed, this sub-process comprising:
step a, detecting whether it is necessary to translate the entire grid map, wherein when a grid actually used in one direction of an x axis or a y axis of the grid map has reached a boundary of the entire grid map and the remaining grids are not used in an opposite direction of an x axis or a y axis of the grid map, proceeding to step b, and otherwise, quitting the sub-process;
step b, determining the number of grids to be actually translated at this time according to a difference between the number of previous offset grids of the x axis and the y axis and the number of current offset grids of the x axis and the y axis; and
step c, translating the entire grid map according to the number of grids to be actually translated at this time.

8. The method for creating the grid map of the intelligent robot as claimed in claim 7, wherein the method of step a in the grid map translation sub-process comprises:
step a1, updating maximum and minimum values x-min, x-max, y-min, and y-max of used grids in the x axis and the y axis of the grid map respectively;
step a2, determining whether (x-max+x-offset) is approximate to the boundary, but (x-min+x-offset) is not approximate to the boundary, when (x-max+x-offset) is approximate to the boundary but (x-min+x-offset) is not approximate to the boundary, making x-offset minus one and proceeding to step a4, otherwise, proceeding to step a3;
step a3, determining whether (x-min+x-offset) is approximate to the boundary, but (x-max+x-offset) is not approximate to the boundary, when (x-min+x-offset) is approximate to the boundary but (x-max+x-offset) is not approximate to the boundary, making x-offset plus one and proceeding to step a4, otherwise, directly proceeding to step a4;
step a4, determining whether (y-max+y-offset) is approximate to the boundary, but (y-min+y-offset) is not approximate to the boundary, when (y-max+y-offset) is approximate to the boundary but (y-min+y-offset) is not approximate to the boundary, making y-offset minus one and proceeding to step a6, otherwise, proceeding to step a5;
step a5, determining whether (y-min+y-offset) is approximate to the boundary, but (y-max+y-offset) is not approximate to the boundary, when (y-min+y-offset) is approximate to the boundary but (y-max+y-offset) is not approximate to the boundary, making y-offset plus one and proceeding to step a6, otherwise, directly proceeding to step a6; and
step a6, determining whether x-offset or y-offset changes, when x-offset or y-offset changes, starting to translate the entire grid map, otherwise, quitting the sub-process,
wherein x-min and x-max are minimum and maximum values of the used grid in the x-axis direction, y-min and y-max are minimum and maximum values of the used grid in the y-axis direction, and x-offset and y-offset record actual grid offsets in the x-axis and y-axis directions of the current grid map.

9. The method for creating the grid map of the intelligent robot as claimed in claim 8, wherein the method of step b in the grid map translation sub-process comprises:
step b1, setting actul-x-offset=x-offset-old-x-offset, and actul-y-offset=y-offset-old-y-offset;
step b2, determining whether actul-x-offset is less than 0, when actul-x-offset is less than 0, determining that the entire grid map moves for abs (actul-x-offset) grids toward a negative direction of the x-axis and proceeding to step b4, otherwise, proceeding to step b3;
step b3, determining whether actul-x-offset is greater than 0, when actul-x-offset is greater than 0, determining that the entire grid map moves for abs (actul-x-offset) grids toward a positive direction of the x-axis and proceeding to step b4, otherwise, directly proceeding to step b4;
step b4, determining whether actul-y-offset is less than 0, when actul-y-offset is less than 0, determining that the entire grid map moves for abs (actul-y-offset) grids toward a negative direction of the y-axis and proceeding to step b6, otherwise, proceeding to step b5;
step b5, determining whether actul-y-offset is greater than 0, when actul-y-offset is greater than 0, determining that the entire grid map moves for abs (actul-y-offset) grids toward a positive direction of the y-axis and proceeding to step b6, otherwise, directly proceeding to step b6; and
step b6, updating the grid offsets old-x-offset and old-y-offset in the x-axis and y-axis directions during the previous translation of the grid map with the actual grid offsets x-offset and y-offset in the x-axis and y-axis directions of the current grid map,
wherein x-offset and y-offset record the actual grid offsets in the x-axis and y-axis directions of the current grid map, old-x-offset and old-y-offset record the grid offsets in the x-axis and y-axis directions during the previous translation of the grid map, abs indicates an absolute value of this number, and actul-x-offset and actul-y-offset are the number of grids to be actually translated at this time.

10. The method for creating the grid map of the intelligent robot as claimed in claim 9, wherein the method of translating the x-axis toward a negative direction when actul-x-offset is less than zero in step c in the grid map translation sub-process comprises:
step c1, setting x=0, y=0, and start-x=0 during starting;
step c2, determining whether x is less than Height, when x is less than Height, proceeding to step c3, otherwise, ending;
step c3, setting count=0, and proceeding to step c4;
step c4, determining whether y is less than Width, when y is less than Width, proceeding to step c5, otherwise, setting x++ and returning to step c2;
step c5, determining whether start-x!=0, when start-x!=0, proceeding to step c51, otherwise, proceeding to step c6;
step c51, determining whether global-map[x][y]!=0, when global-map[x][y]!=0, setting global-map[x+actul-x-offset][y]=global-map[x][y], global-map[x][y]=0 and proceeding to step c8, otherwise, setting count++ and proceeding to step c8;
step c6, determining whether global-map[x][y]!=0, when global-map[x][y]!=0, proceeding to step c7, otherwise, proceeding to step c8;
step c7, setting start-x=x, global-map[x+actul-x-offset][y]=global-map[x][y], global-map[x][y]=0, and proceeding to step c8; and
step c8, determining whether count==Width, when count==Width, ending, otherwise, setting y++ and returning to step c4,
wherein global-map is a grid map array, Height and Width represent the height and width of the global-map grid array, start-x represents a row number of a first row with data not zero, that is, data from the beginning of the row is to be translated, and count records how many grids in a row of data are zero; and
when actul-x-offset is greater than zero, in the above flow chart, an initial value of x is set to Height−1, after each cycle, x−− is executed, and the process ends until x<0, the translation principle of the y-axis being the same as that of the x-axis.

11. The method for creating the grid map of the intelligent robot as claimed in claim 10, wherein when a translation function is activated, a small amount of memory is opened as a buffer to store grid map data that has been out of bounds, and when the entire grid map is translated, the buffered grid data is written to the grid map.

12. The method for creating the grid map of the intelligent robot as claimed in claim 11, wherein the process of reading data in a buffer process is as follows:
step S1, setting x-index=x+x-offset, and y-index=y+y-offset;
step S2, determining whether (x-index, y-index) is in the grid map and the grid map translation function is not activated, when (x-index, y-index) is in the grid map and the grid map translation function is not activated, proceeding to step S3, otherwise, proceeding to step S2a;
step S2a, reading from the buffer, and proceeding to step S2b;
step S2b, determining whether reading is successful, when the reading is successful, proceeding to step S4, otherwise, proceeding to step S2c;
step S2c, determining whether (x-index, y-index) is in the grid map, when (x-index, y-index) is in the grid map, proceeding to step S2d, otherwise, returning to zero and ending;
step S2d, directly reading the corresponding grid map data and proceeding to step S4;
step S3, directly reading the corresponding grid map data and proceeding to step S4; and
step S4, returning a read value and ending,
the process of writing data in the buffer process is as follows:
step T1, reading an (x, y) value and proceeding to step T2;
step T2, determining whether a written value is equal to the read value, when the written value is equal to the read value, ending, otherwise, setting x-index=x+x-offset and y-index=y+y-offset, and proceeding to step T3; and
step T3, determining whether (x-index, y-index) is in the grid map and the grid map translation function is not activated, when (x-index, y-index) is in the grid map and the grid map translation function is not activated, directly writing data into the corresponding grid map data and ending, otherwise, writing data into the buffer and ending,
wherein x and y are the grid coordinates at which the intelligent robot is currently located, and x-index and y-index are the actual coordinates of the corresponding grid map.
